(19) United States
(12) Patent Application Publication
(10) Pub. No.: US 2012/0173816 A1
(43) Pub. Date: Jul. 5, 2012

(54) ELECTRONIC DEVICE AND METHOD FOR ASSOCIATING MEMORY CARD WITH ELECTRONIC DEVICE

(75) Inventor: CHENG-HUANG LU, Shenzhen City (CN)

(73) Assignees: HON HAI PRECISION INDUSTRY CO., LTD., Tu-Cheng (TW); Fu Tai Hua Industry (Shenzhen) Co.,Ltd., ShenZhen City (CN)

(21) Appl. No.: 13/158,468

(22) Filed: Jun. 13, 2011

(30) Foreign Application Priority Data
Dec. 31, 2010 (CN) 201010619586.1

(51) Int. Cl. G06F 12/00

(52) U.S. Cl. 711/115; 711/E12.001

(57) ABSTRACT

An electronic device for associating at least one memory card and data therein with itself and a method thereof are provided. The device includes a storage unit storing a relationship between one or more identity codes and corresponding associated information. The association information corresponding to each identity code records relationship between at least one application capable of being run by the device and associated data stored in a memory card having the identity code. A processor determines the identity code of a memory card connected to the electronic device, determines the corresponding association information based on the determined identity code and the stored relationship, and associates the at least one application with the associated data according to the determined association information.

### BACKGROUND

1. Technical Field

The present disclosure relates to electronic devices and, more particularly, to an electronic device for associating at least one memory card with itself and a method thereof.

2. Description of Related Art

Memory cards are widely used in electronic devices such as digital cameras, smart phones, and personal digital assistants. An electronic device may be set by a user to retrieve and use data stored in a memory card when the memory card is electrically connected to the electronic device. For example, the electronic device may be set to play an audio file when its alarm clock application is run. However, the relationship created between the audio file and the alarm clock application disappears from the electronic device when the memory card is removed from the electronic device. Thus, when the memory card is reconnected to the electronic device again, the user must reset the electronic device to re-establish the relationship for playing the audio file from the memory card when the alarm clock application goes off again, which is inconvenient to the user.

Therefore, it is desirable to provide an electronic device for associating at least one memory card with itself and a method thereof to solve the problems mentioned above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device in accordance with an exemplary embodiment.

FIG. 2 is a flowchart of a method for associating at least one memory card with the electronic device of FIG. 1, in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

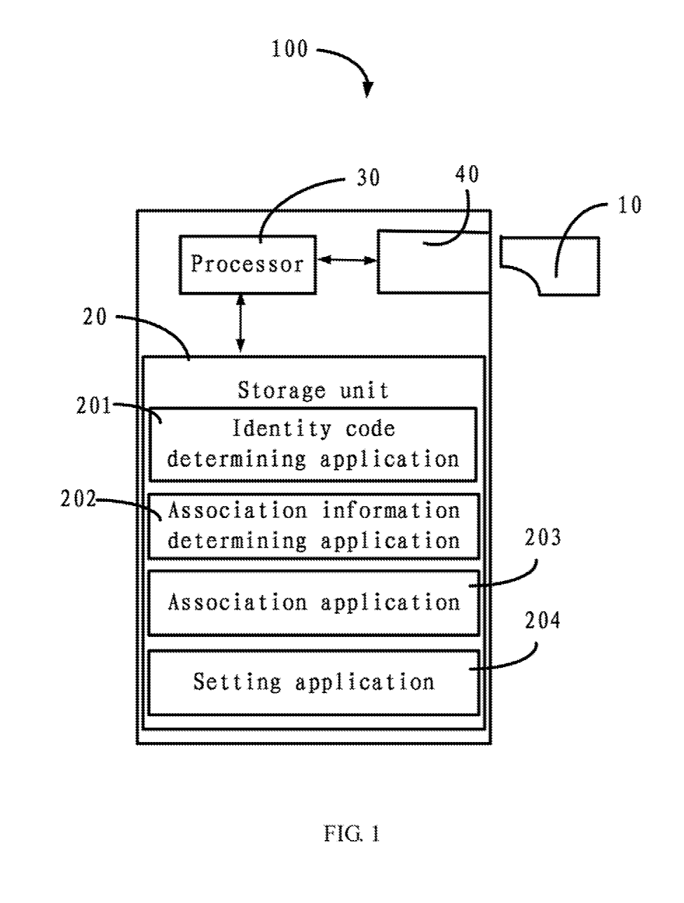

Referring to FIG. 1, an electronic device 100 capable of being connected to at least one memory card 10 is illustrated. The electronic device 100 includes kinds of applications such as an alarm clock application. When the electronic device 100 runs one application, the electronic device 100 may seek and retrieve some data associated with that application in the at least one memory card 10 connected to the electronic device 100. For example, when the electronic device 100 runs the alarm clock application, the electronic device 100 may invoke an audio file stored in the memory card 10 connected to the electronic device 100. In this embodiment, the electronic device 100 may be a smart phone, a portable DVD player, an MP3 player, or an MP4 player.

The electronic device 100 includes a storage unit 20 and a processor 30. The storage unit 20 stores a relationship between one or more identity codes and corresponding association information. In this embodiment, the relationship may be stored in a table as shown below.

| Identity codes | Association information |
|---|---|
| code 1 | associated information 1 |
| code 2 | associated information 2 |
| . . . | . . . |

As shown in the table, each identity code corresponds to one item of associated information. The identity code is used for identifying the memory card 10. The association information corresponding to each identity code records relationship between at least one application capable of being run by the electronic device 100 and associated data stored in a memory card 10 having the identity code. The associated data will be employed by the at least one application when the memory card 10 is connected to the electronic device 100. In this embodiment, the electronic device 100 includes at least one socket or slot (slot 40) for receiving at least one memory card 10. The at least one memory card 10 may be any type of memory cards, for example, an SD card, an CF card, or the like, and the at least one socket or slot may receive any type of memory card.

The storage unit 20 further stores an identity code determining application 201, an association information determining application 202, and an association application 203. The processor 30 executes software in the storage unit 20 to perform various functions of the electronic device 100. The identity code determining application 201 includes software which may be implemented by the processor 30 to determine the identity code of the memory card 10 connected to the electronic device 100. The association information determining application 202 includes software which may be implemented by the processor 30 to determine the corresponding association information based on the determined identity code and the stored relationship. The association application 203 includes software which may be implemented by the processor 30 to associate the at least one application and the associated data stored in the memory card 10 according to the determined association information. Thus, when the at least one application is run, the corresponding associated data stored in the memory card 10 is employed.

In this embodiment, the storage unit 20 further stores a setting application 204. The setting application 204 includes software which may be implemented by the processor 30 to record and reset the association information, and store the association information in the storage unit 20. The set association information maintains relationship between the at least one application and the associated data according to the set association information despite one or more connections and disconnections between the memory card and the electronic device, until the association information is reset by the user.

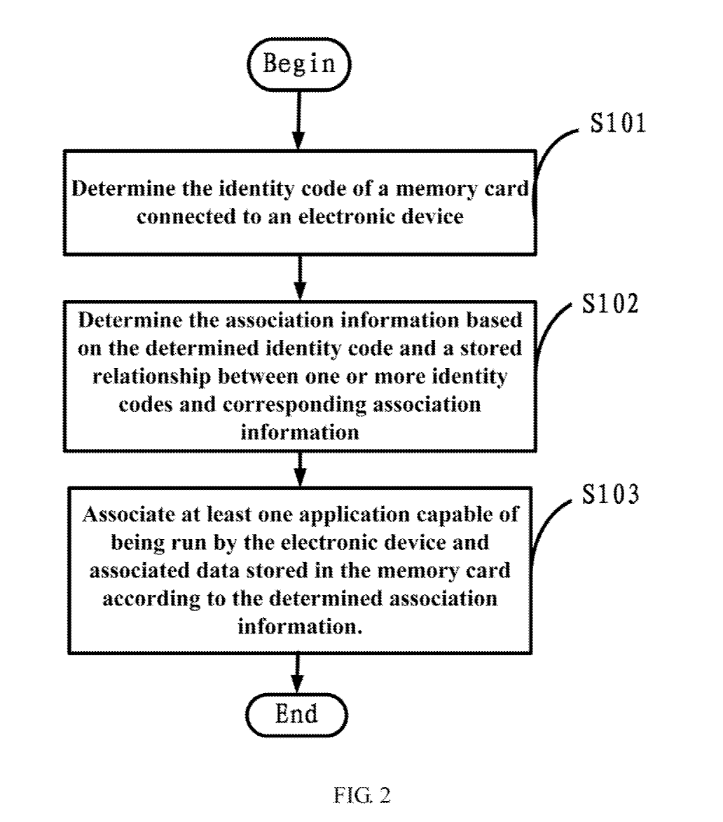

Referring to FIG. 2, a flowchart of a method for associating the at least one memory card 10 with the electronic device 100 is illustrated.

In step S101, the identity code determining application 201 is implemented by the processor 30 to determine the identity code of the memory card 10 connected to the electronic device 100.

In step S102, the association information determining application 202 is implemented by the processor 30 to determine the corresponding association information based on the determined identity code and the stored relationship.

In step S103, the association application 203 is implemented by the processor 30 to associate the at least one application and the associated data stored in the memory card according to the determined association information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a storage unit storing a relationship between one or more identity codes and corresponding association information, the association information corresponding to each identity code recording relationship between at least one application capable of being run by the electronic device and associated data stored in a memory card having the identify code, the associated data to be employed by the at least one application when the memory card is connected to the electronic device, the storage unit further storing a plurality of modules; and
a processor to execute the plurality of modules;
wherein the plurality of modules comprises instructions executable by the processor to:
determine the identity code of the memory card connected to the electronic device;
determine the corresponding association information based on the determined identity code and the stored relationship; and
associate the at least one application and the associated data stored in the memory card according to the determined association information.

2. The electronic device as described in claim 1, wherein the plurality of modules further comprises instructions executable by the processor to record and reset the association information, and store the association information in the storage unit.

3. The electronic device as described in claim 2, wherein the plurality of modules further comprises instructions executable by the processor to maintain relationship between the at least one application and the associated data according to the association information despite one or more connections and disconnections between the memory card and the electronic device, until the association information is reset by the user.

4. The electronic device as described in claim 1, wherein the electronic device is a smart phone, a portable DVD player, an MP3, or an MP4.

5. A method for associating at least one memory card with an electronic device, the electronic device storing a relationship between one or more identity code and corresponding association information, the association information corresponding to each memory card recording relationship between at least one application capable of being run by the electronic device and associated data stored in a memory card having the identity code, the associated data to be employed by the at least one application when the memory card is connected to the electronic device, the method comprising:
determining the identity code of the memory card connected to the electronic device;
determining the corresponding association information based on the determined identity code and the stored relationship; and
associating the at least one application and the associated data stored in the memory card according to the determined association information.
